(19) United States
(12) Patent Application Publication
(10) Pub. No.: US 2026/0048505 A1
(43) Pub. Date: Feb. 19, 2026

(54) ROBOTIC TASK COMPLETION FROM NATURAL LANGUAGE REQUESTS

(71) Applicant: The Johns Hopkins University, Baltimore, MD (US)

(72) Inventors: Corban G. Rivera, Dayton, MD (US); William A. Paul, Columbia, MD (US); David A. Handelman, Clarksville, MD (US); Emma A. Holmes, Laurel, MD (US); Andrew R. Badger, Baltimore, MD (US)

(21) Appl. No.: 19/238,047

(22) Filed: Jun. 13, 2025

Related U.S. Application Data
(60) Provisional application No. 63/683,748, filed on Aug. 16, 2024.

(51) Int. Cl. B25J 9/16

(52) U.S. Cl. CPC B25J 9/1661; B25J 9/163; B25J 9/1658; B25J 9/1664

(57) ABSTRACT

A computer-implemented method, apparatus and system is provided for robotic task completion from natural language requests. The method may include: receiving a natural language command, processing the natural language command with a generative large language model to extract an intent and associated context, creating a three-dimensional (3D) open-vocabulary semantic scene graph of the environment, associating the scene graph with the intent and associated context, creating, based at least in part on the scene graph, an execution plan comprising a sequence of actions to complete the natural language command, and generating executable code or tool calls corresponding to one or more actions in the sequence of actions, and controlling one or more robotic manipulators and/or actuators to perform one or more actions of the sequence of actions based on the execution plan.

### CROSS-REFERENCE TO RELATED APPLICATIONS

This application claims priority to U.S. Provisional Patent Application No. 63/683,748, filed Aug. 16, 2024, which is incorporated herein by reference in its entirety.

### STATEMENT OF GOVERNMENTAL INTEREST

This invention was made with Government support under Cooperative Agreement Number W911NF-21-2-0211 awarded by the Army Research Laboratory. The Government has certain rights in the invention.

### BACKGROUND

Existing robotic platforms often exhibit fragility, rigidity, and struggle when confronted with unforeseen circumstances. Further, existing platforms rely on pre-scanned environments, which limits their use to well-known environments. Robotic models typically function optimally only within familiar settings.

### BRIEF SUMMARY

The following summary is merely intended to be an example. The summary is not intended to limit the scope of the claims.

In accordance with one aspect, a computer-implemented method is provided for robotic task completion from natural language requests. The method may include: receiving a natural language command, processing the natural language command with a generative large language model to extract an intent and associated context, creating a three-dimensional (3D) open-vocabulary semantic scene graph of the environment, the scene graph comprising nodes for objects and object parts annotated with features from a vision-language model and edges representing relationships, and associating the scene graph with the intent and associated context, creating, based at least in part on the scene graph, an execution plan comprising a sequence of actions to complete the natural language command, wherein creating the execution plan comprises operating in a closed-loop with iterative refinement and predicate grounding by: determining a plurality of plausible actions based at least in part on a current state of the robot and the intent and associated context, generating one or more preconditions for each plausible action of the plurality of plausible actions, determining, for each plausible action, whether that plausible action meets or is likely to meet the one or more preconditions by validating against the scene graph, self-reflectively evaluating and revising one or more branches of the tree search when a feasibility threshold is not met, determining the sequence of actions comprising a set of the plausible actions that meets or is likely to meet the one or more preconditions associated with a respective plausible action of the set of plausible actions, and generating executable code or tool calls corresponding to one or more actions in the sequence of actions, and controlling one or more robotic manipulators and/or actuators to perform one or more actions of the sequence of actions based on the execution plan.

In accordance with another aspect, a computer-implemented method is provided for robotic task completion from natural language requests. The method may include: parsing, with a generative large language model (LLM), free-form instructions to extract intent and context information, creating a three-dimensional (3D) environmental model of a surrounding environment of the apparatus, wherein the 3D environmental model represents objects, object parts, and inter-object relationships with labels derived from one or more vision-language models (VLMs), and generating, with a closed-loop planner, at least one action based at least in part on the intent and context information and the 3D environmental model.

According to some aspects, there is provided the subject matter of the independent claims. Some further aspects are provided in subject matter of the dependent claims.

### BRIEF DESCRIPTION OF THE DRAWINGS

The foregoing aspects and other features are explained in the following description, taken in connection with the accompanying drawings.

FIG. 1 depicts an example block diagram depicting a method for according to one or more embodiments described herein.

FIGS. 2A-2C depict example natural language-driven task execution in accordance with embodiments described herein.

FIG. 3 depicts example closed-loop task planning and execution in accordance with embodiments described herein.

FIGS. 4A-4F depict an example natural language-driven task execution in accordance with embodiments described herein.

FIGS. 5A, 5B, and 6 depict example methods for completing robotic tasks from natural language requests in accordance with embodiments described herein.

FIG. 7 depicts an example computer system and apparatus for completing robotic tasks from natural language requests in accordance with embodiments described herein.

### DETAILED DESCRIPTION

The subject matter will now be described in detail for specific preferred embodiments. It is understood that the described embodiments are intended only as illustrative examples and are not to be limited thereto.

One problem of real-time task execution in open-world environments is that real-time task execution may be driven by unconstrained natural language goals. In such scenarios, a key challenge lies in enabling a robotic system to understand and act upon complex context-dependent language instructions, while simultaneously adapting to dynamic and unstructured environments.

To address such problems, the inventors have discovered, inter alia, systems and methods for providing a natural language driven robotic platform designed for task execution in unstructured environments (the “robotic platform”). The robotic platform may provide scalability and reliability of Large Language Model (LLM) based planning in complex state and action spaces. Additionally, technical effects achieved by the disclosed platform may include, for example, predicate grounding to prevent and recover from infeasible actions and an embodied version of LLM-guided Monte Carlo Tree Search (MCTS) (LLM-MCTS) with self-reflection. The disclosed platform combines these planning enhancements with dynamic language aligned three-dimensional (3D) scene graphs and large multi-modal pre-trained models to perceive, localize, and interact with its environment, enabling reliable task completion.

In some embodiments, a natural language-driven robotic platform designed for task execution in unstructured settings is provided. The robotic platform may integrate advanced perception, manipulation, movement, speech, coding, and search primitives. This integration may allow the robotic platform to tackle a wide variety of tasks described in natural language. In some cases, the robotic platform may combine large multi-modal pre-trained models with novel planning and reasoning enhancements, enabling robust task execution in complex, dynamic environments.

In some embodiments, the robotic platform may provide systems and methods for formal pre-condition verification. The robotic platform may integrate pre-condition grounding, a mechanism that formally verifies action constraints before execution, preventing infeasible actions and facilitating failure recovery. This mechanism may ensure that the robotic platform can maintain task progress, even in unstructured environments. Formal pre-condition verification significantly may enhance the robotic platform's ability to recover from failure, leading to higher task completion rates and more reliable execution.

In some embodiments, the robotic platform may provide systems and methods for LLM-Guided MCTS. The robotic platform may use an LLM-guided tree search with self-reflection, enabling the robotic platform to explore future states and refine action sequences dynamically. This approach may significantly improve planning efficiency and task completion rates, even in large, open-world state spaces. By integrating LLM-guided tree search with closed-loop task execution and self-critique, the robotic platform may effectively refine its action sequences, achieving competitive task completion performance with far fewer expansion steps than convention LLM-based systems.

In some embodiments, the system may have the ability to continuously interpret natural language expressions without predefined constraints, translating the natural language expressions into actionable plans in real-time. In some cases, full scene understanding may be achieved through a combination of an incrementally-updating language-aligned 3D scene graph and large pre-trained multi-modal models.

Given the open-world nature of the problem, the system may have the ability to generalize across varying environments and manage unknown objects, unforeseen obstacles, and unexpected environmental changes. A primary metric for success may be task completion rate, underscoring the importance of reliable, autonomous decision-making in diverse and unpredictable contexts.

### Example Implementation of a Robotic Platform

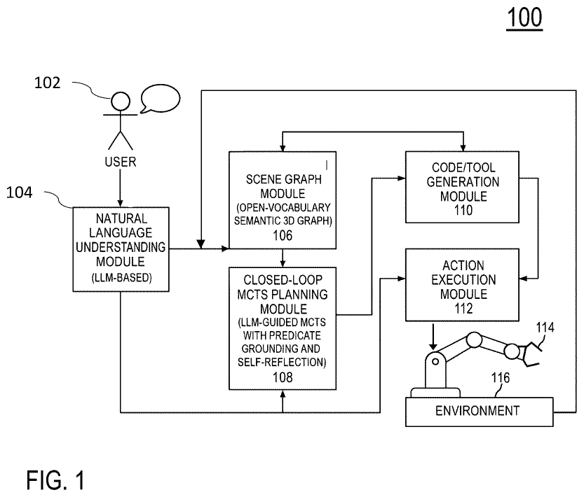

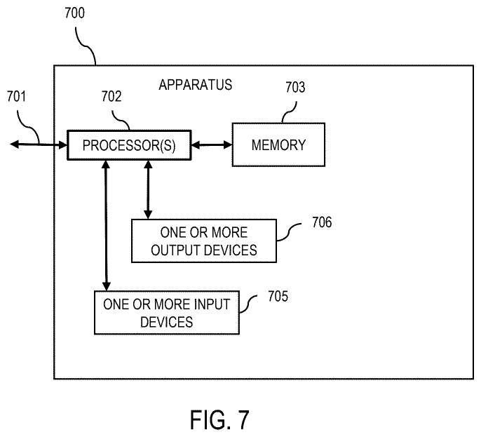

FIG. 1 provides a process flow 100 for robotic task completion from a natural language request. Process flow 100 may be implemented by computing device 700 (shown in FIG. 7) where computing device 700 is an instance of, or a part of, robot 114 as described herein. Process flow 100 may be implemented by one or more processors, such as processor 702 of FIG. 7. Robot 114 may include one or more memories, such as memory 703 of FIG. 7, that may store one or more software modules, such as natural language understanding module 104, scene graph module 106, closed-loop MCTS planning module 108, code/tool generation module 110, and action execution module 112.

Robot 114 may include one or more robotic manipulators and/or actuators to interact with the environment and/or to move through the environment. For example, the robot may include: one or more robotic manipulators but no actuators; one or more actuators but no robotic manipulators; or one or more robotic manipulators and one or more actuators. For example, a robotic manipulator may be a mechanical system designed to mimic the movement of a human arm. For example, a robotic manipulator may be a device mounted to the robot and may have one or more links and/or one or more joints. For example, an actuator may be a hydraulic, pneumatic, and/or electric actuator. In some embodiments, the one or more robotic manipulators and/or actuators may enable the robot to navigate through the environment, grasp one or more items in the environment, and/or manipulate one or more items in the environment.

Process flow 100 of FIG. 1 provides an example of task planning and execution by robot 114 in an environment 116 in response to a request made by user 102. User 102 may, in some embodiments, provide a request to robot 114 via an interface, such as a graphical user interface of a computing device (e.g., laptop, smartphone) that is communicatively-coupled to robot 114. Additionally, or alternatively, robot 114 may accept a request from user 102 via an input device of robot 114, such as a touch screen that functions as an input/output device, a microphone, or the like. Robot 114 may provide integration of natural language understanding, semantic world modeling, closed-loop planning, and robotic control into a unified system capable of executing arbitrary user commands. At 104, processor 702 may parse the request to extract intent and context. For example, a generative large language model may parse free-form instructions to extract intent and context. At 106, the intent may be grounded in a dynamically built, open-vocabulary 3D scene graph that represents objects, object parts, and inter-object relationships with labels derived from vision-language models. At 108, processor 702, with a closed-loop planner, may iteratively refine a sequence of actions. The closed-loop planner may generate one or more plausible actions, formulate and check their preconditions against the scene graph, and assembles a plan that satisfies the command. At 110, processor 702 may generate code and/or tool calls that translate the assembled plan into control signals for manipulators of robot 114. At 112, processor 702 may execute the control signals causing robot 114 to interact with elements of environment 116. Additionally, or alternatively, the control signals may cause robot 114 to move around environment 116. The process flow may further include feedback from the environment 116 to the scene graph module 106. This layered architecture-melding LLM-driven natural language understanding, semantic scene graphs, predicate-grounded planning, and on-the-fly code/tool generation—may establish a framework for flexible, real-time human-robot interaction.

### Example Natural Language-Driven Task Execution

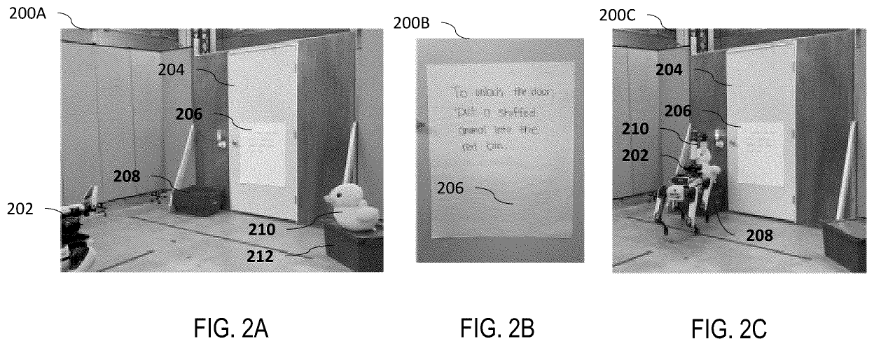

FIGS. 2A-2C provides an example of natural language-driven task execution in accordance with embodiments described herein. In some embodiments, natural language-driven task execution may be performed in real-time and in open-world environments. In one example embodiment, a problem may require a robot to operate in unfamiliar settings and manipulate novel objects to complete tasks described in unconstrained natural language. Referring to FIGS. 2A-2C, an escape room motivated example is depicted, where the task given to robot 202 is to “unlock the door.” Referring to FIG. 2A, in scene 200A, robot 202 must identify objects (e.g., door 204, note 206, bin 208, toy 210, and box 212) and understand the context of the scene. In scene 200A, door 204 is in a locked state, as indicated by the red light to the left of the door. Referring to FIG. 2B, scene 200B depicts a closer view of note 206 which is a hand written note on door 204 with additional instructions (“To unlock the door, put a stuffed animal into the red bin.”). Referring to FIG. 2C, scene 200C depicts robot 202 completing the task by picking up stuffed animal 210 and putting into bin 208. As a result, door 204 is changed from a locked state to an unlocked state, which is indicated by the light to the left of the door turning from red to green.

### Example Closed Loop Task Planning and Execution

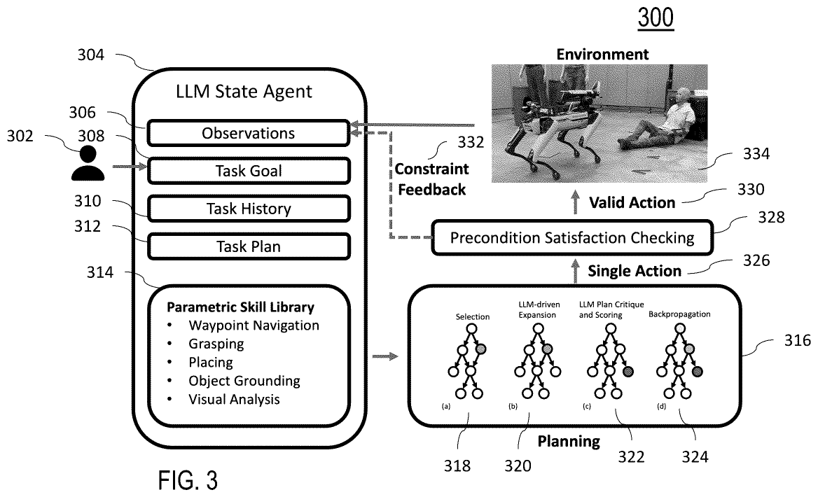

FIG. 3 provides an example framework 300 of closed loop task planning and execution in accordance with embodiments described herein. Framework 300 may respond to natural language task requests by planning and executing actions in a closed loop over a series of steps. Intermediate feedback in the form of abstracted environment observations and information about unsatisfied action constraints (e.g., precondition grounding) may allow a robot of framework 300 to adapt and recover in real-time. User 302 may be provided with an interface of LLM state agent 304, such as via a portable computing device or the like. In some embodiments, real-time feedback may be to user 302 of the robot regarding at least one of the actions in the sequence of actions of the execution plan. Interface of LLM state agent 304 may provide a status of current task planning execution. Interface of LLM state agent 304 may include, for example, observations 306, task goal 308, task history 310 and task plan 312. Status of the task planning and execution may be composed of a text description of the objective, task relevant observations, and task history. Some or all of the objective, task relevant observations and task history may be combined with the details of parametric skills library 314. Parametric skills library 314 may include, for example, waypoint navigation, grasping, placing, object grounding, and visual analysis. Tree-based planning 316 may include selection 318, LLM-driven expansion 320, LLM plan critique and scoring 322, and backpropagation 324. Selection 318 and backpropagation 324 may be conducted like a Monte-Carlo Tree Search. In this example, planning 316 may output single action 326. Single action 326 may be subjected to precondition satisfaction checking 328. Constraint feedback 332 may be a result from precondition satisfaction checking 328. Constraint feedback 332 may be provided to LLM state agent 304 and stored with observations 306. When precondition satisfaction checking 328 determines that single action 326 is valid, valid action 330 may be executed, such as by the robot in environment 334.

In some embodiments, framework 300 may include extending an LLM-guided tree search to a real-world domain. An LLM-guided tree search may follow the particular phases of a Monte Carlo Tree Search (MCTS), which may include selection 318, expansion 320, critique and scoring 322, and backpropagation 324. Framework 300 may provide LLM-based enhancements to expansion 320 and critique and scoring 322, examples of which are described herein.

In some embodiments, selection may be based on an upper confidence bound. For example, selection 318 may be based on the Upper Confidence Bound (UCB1) algorithm, which balances exploration and exploitation in selecting the next node to explore. For a node sₜ with child nodes aᵢ, the UCB1 criterion may be used to select the action that maximizes the following equation:

$${a}^{*} = arg {max}_{{a}_{i}} [ Q ( {s}_{t} , {a}_{i} ) + c \cdot \sqrt{\frac{log N ( {s}_{t} )}{N ( {s}_{t} , {a}_{i} )}} ]$$

where Q(sₜ, aᵢ) is the expected reward of taking action aᵢ at state sₜ, N(sₜ) is the number of times state sₜ has been visited, N(sₜ, aᵢ) is the number of times action aᵢ has been taken from sᵣ, and c is a constant controlling the exploration-exploitation tradeoff.

In some embodiments, during expansion 320, traditional MCTS may add new child nodes representing possible future states. For embodied tasks, the state-action space may explode at even small depths in the tree search, requiring a powerful heuristic to filter out irrelevant states. In some cases, the common sense of LLMs may be used to serve as this heuristic. Given a current state sₜ and a natural language task goal g, the LLM may generate a set of plausible actions Aₜ=(s_{t,g}). These actions may then be added to the tree as new nodes, representing potential transitions from sₜ. This LLM-guided expansion allows for the exploration of a broader range of actions that align with the natural language task, thus avoiding state space explosion and improving task understanding and goal relevance.

In some embodiments, LLM-based plan critique and scoring 322 may be provided. In a traditional MCTS framework, a simulation phase may evaluate state transitions through random rollouts in an environment that backpropagates the value of the terminal state of that random rollout. For the robotic platform described herein, the traditional MCTS framework may be replaced with an LLM-based critique mechanism that assesses a planned sequence of actions holistically. At the leaf node of the search tree, rather than simulating state transitions, the LLM critic is given the sequence of actions planned from time t to t+k. The LLM evaluates the efficiency, relevance, and goal alignment of the entire plan, producing a planning score that serves as the reward signal for backpropagation 324.

Formally, let τ={aₜ, aₜ, +1, . . . , aₜ₊ₖ} be the sequence of planned actions from state sₜ over k time steps. The LLM critic, L, is tasked with evaluating the quality of this action sequence in achieving the task goal g. The critique score C(τ, g) reflects how well the action sequence satisfies the task requirements and the efficiency of the plan. The score incorporates penalties for unnecessary steps or inefficient actions.

Once the critique score C(sₜ₊ₖ, g) is obtained, backpropagation 324 may proceed as in standard MCTS. The critique score may be propagated back through the tree, updating the value estimates Q(s, a) for each state-action pair along the trajectory τ. The update rule for each node is as follows:

$$Q ( {s}_{t} , {a}_{i} ) ← \frac{1}{N ( {s}_{t} , {a}_{i} )} {\sum }_{j = 1}^{N ( {s}_{t} , {a}_{i} )} C ( {τ}_{j} , g ) ,$$

where N(sₜ, aᵢ) is the number of times the action a; has been selected from state sₜ, and C(τⱼ, g) is the critique score from the j-th simulation. This ensures that the robotic platform's planning decisions reflect the accumulated knowledge from both successful and unsuccessful action sequences.

In some embodiments, once MCTS with LLM-guided expansion and critique-based scoring identifies the optimal action sequence, the robotic platform may attempt to execute the chosen next action. If, for example, the tool execution fails, the robotic platform must contextualize the failure with respect to the planning history to determine proper recovery measures. For example, upon failing to search inside a cabinet, the robotic platform must analyze its previous actions and determine a reason for the execution failure. In this case, there may be many possible reasons: the cabinet is not open, the robot has not moved within reach of the cabinet, the robot is currently holding an object and cannot execute the search tool due to manipulator constraints, etc. In some cases, extrapolating such broad conclusions from the action history is a complicated endeavor. To improve robot recovery capabilities, precondition grounding through precondition satisfaction checking 328 may be provided as an enhancement to the LLM planner. The precondition grounding may be autonomously generated, promoting scalability, and enables formal validation and recovery feedback during tool execution, greatly improving task completion.

In some embodiments, the robotic platform may provide LLM-derived preconditions for action feasibility. Precondition grounding may require a defined set of preconditions for each tool of the robot. At inference time, these preconditions may be verified by formal methods to ensure that a chosen tool can be executed given the perceived state of the environment. Additionally, or alternatively, the robotic platform may be prompted to generate one or more predicate-based preconditions for each tool of the robot. In some cases, the predicate-based preconditions may encode the logical requirements for successful tool execution. In one example, let A={a₁, . . . , aₙ} represent the set of n actions available to the robot. Then, Pᵢ=LLM (S, nᵢ, dᵢ, atts) is the set of preconditions for aᵢ generated by conditioning the LLM on the system prompt, S, action name, nᵢ, action description, dᵢ, and list of object and robot boolean attributes, atts. At time, t, define the formal verification function, F(sₜ, P_{c}), as:

$$F ( {s}_{t} , {P}_{c} ) = \{ \begin{matrix}1 , & if {P}_{c} is satisfied in {s}_{t} \\ 0 , & if {P}_{c} is not satisfied in {s}_{t}\end{matrix}$$

where c represents the index of the chosen action in A and sₜ represents the state of the system at time, t. If F(sₜ, P_{c})=1, then the action, ac, determined to be a valid action 330 and is executed in environment 334. If F(sₜ, P_{c})=0, then the action is deemed infeasible and execution is aborted.

In some embodiments, the robotic platform my provide systems and methods for providing feedback for future planning. Constraint feedback 332 detailing the findings of valid and invalid actions may be provided to observations 306 of LLM state agent 304. When execution is aborted due to unmet preconditions determined at 328, the system may provide explicit feedback 332 to LLM state agent 304, specifying which preconditions were unsatisfied.

For example, let Uc be the set of unsatisfied preconditions for action c in A. If F(sₜ, P_{c})=0, then:

$${U}_{c} = \{ p ∈ {P}_{c} \vert p is not satisfied in {s}_{t} \}$$

The set U_{c} may be formatted and returned to the LLM as feedback, allowing the agent to update its internal model of the environment and adjust future action sequences to avoid proposing actions whose preconditions are unlikely to be met. This iterative feedback loop refines the robot's planning process, improving task completion rates over time by preventing the repetition of infeasible actions and guiding the agent towards valid recovery plans. Additionally, using feedback from U_{c}, the LLM revises its future plans, internalizing the state feedback to adjust the sequence of future actions. The robot can either attempt to satisfy the unsatisfied preconditions or generate alternative actions that are feasible given the current state sₜ. This mechanism ensures that robotic platform's action plans are dynamically adapted to the environment.

In some embodiments, the robotic platform may make use of a library of parametric skills 314. In physical experiments, the skills may include but are not limited to object localization, navigation, grasping, manipulation, visual question answering, speech, code execution, and web search.

### Example Implementation of Robotic Platform

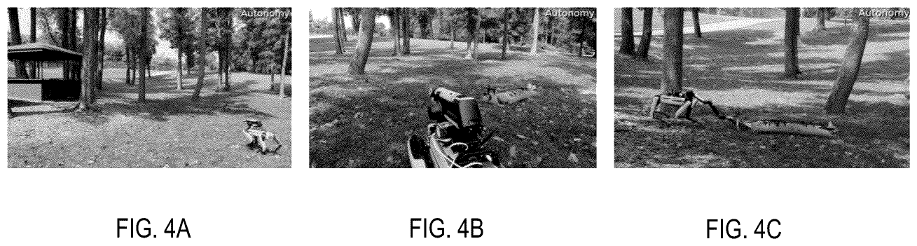

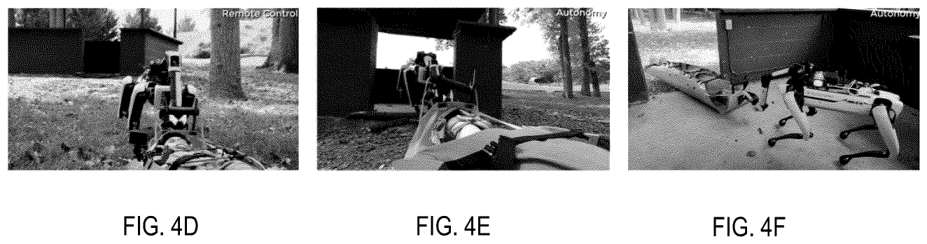

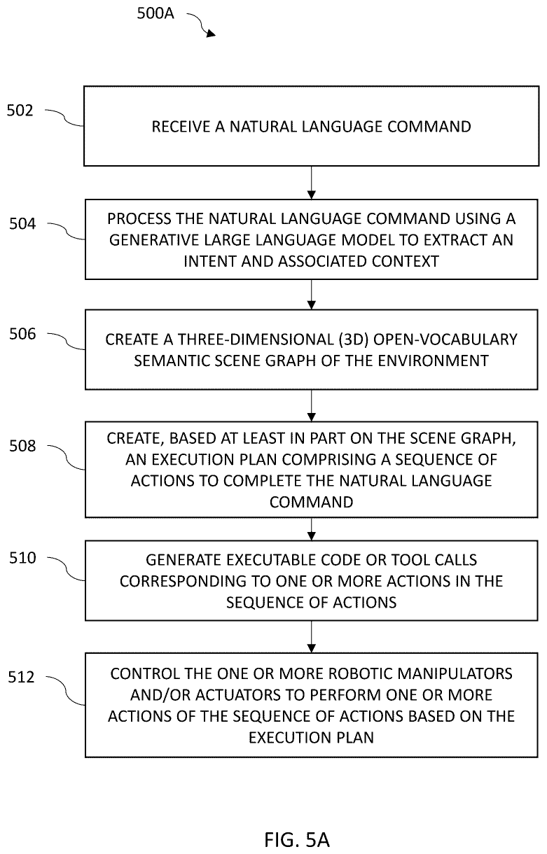

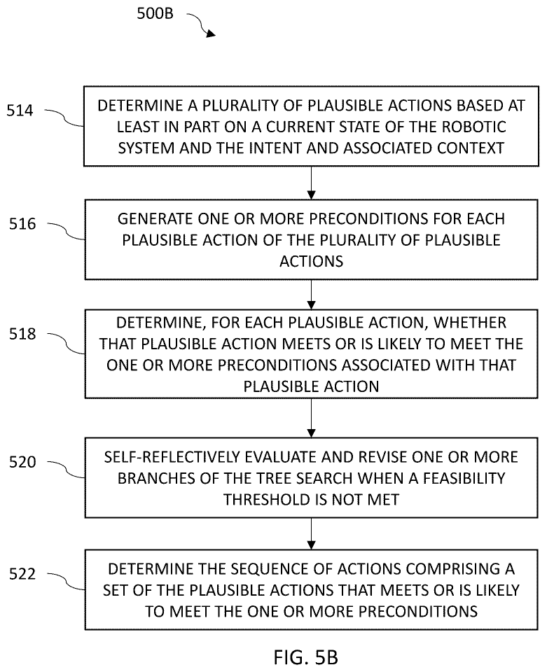

Referring to FIGS. 4A-4F, an example implementation of the disclosed robotic platform is shown and described. In this example, the robotic platform is placed in a robotic casualty evacuation scenario. In one example, through scene understanding provided by foundation models described herein, the robot is provided with the ability to find safe locations on its own. In this example, a medic-robot team is tasked with having a robot pull a casualty out of the line of fire. The robot may be controlled using a combination of autonomy and remote control. In some cases, the a safe destination may be determined by a human (e.g., a medic). Alternatively, the safe destination may be determined by the robotic platform. For example, the robotic platform, through foundation model reasoning, may determine on its own where one or more potential safe locations are given a good view of the environment and an estimate of the location of the adversary.

In some embodiments, the robotic platform may team side-by-side with medics. In this scenario, estimated safe locations may serve as suggestions that the medics may either accept or reject. Alternatively, if the robotic platform is unaided by humans, estimated safe locations may help drive goal-directed autonomous behaviors. This capability may benefit civilian use cases as well, where the robot figures out where to pull an injured person to safety given adverse environmental conditions in search and rescue and/or mass casualty scenarios.

In the example depicted in FIGS. 4A-4F, a robotic platform is issued a command using natural language to evacuate an injured person to a safe location. In FIG. 4A, a robot is shown surveying a scene using foundation model reasoning to identify a safe location and an injured person. In FIG. 4B, the robot is shown moving closer to the injured person. In FIGS. 4C-4F, the robot is shown dragging the injured person to the safe location (e.g., inside an enclosed structure). A series of commands are generated based on the foundation model reasoning to control the robot. For example, commands generated may include commands that control movement of the robot's legs and commands to grab the injured person.

### Example Method of a Robotic Platform

FIGS. 5A and 5B illustrate example method embodiments 500A and 500B, respectively, in accordance with the present technology. While FIGS. 5A and 5B will be discussed in the context of FIG. 1, this is for clarity of explanation purposes only and the method described in FIGS. 5A and 5B should not be considered limited by the block diagram illustrated in FIG. 1. Methods 500A and 500B may be performed, for example, by processor 702 of computer device 700 of FIG. 7 described below. In some embodiments, the method is performed on board the robot, and no part of the method is performed by one or more processors remote from the robot. While an order of operations is indicated in FIGS. 5A and 5B for illustrative purposes, the timing and ordering of such operations may vary where appropriate without negating the purpose and advantages of the examples set forth in detail.

Referring to FIG. 5A, in step 502, processor 702 may receive a natural language command. In some embodiments, prior to receiving the natural language command, the robot is not trained with the natural language command, not provided with the natural language command, or not programmed with the natural language command as a possible input.

In step 504, processor 702 may process the natural language command using a generative large language model to extract an intent and associated context.

In step 506, processor 702 may create a three-dimensional (3D) open-vocabulary semantic scene graph of the environment, the scene graph comprising nodes for objects and object parts annotated with vision-language features and edges for their relationships, and associating the scene graph with the intent and associated context. In some embodiments, prior to encountering the environment, the robot is not trained on the environment.

In step 508, processor 702 may create, based at least in part on the scene graph, an execution plan comprising a sequence of actions to complete the natural language command, wherein creating the execution plan comprises operating in a closed-loop with iterative refinement and predicate grounding. In some embodiments, the robot may create the execution plan as part of an initial encounter with the environment. In some embodiments, the execution plan is not based on a decision tree provided to the robot. In some embodiments, the creating the execution plan may include performing a Monte Carlo Tree Search guided by the generative large language model.

In some embodiments, method embodiment 500A may further include providing real-time feedback to a user of the robot regarding at least one of the actions in the sequence of actions of the execution plan.

In step 510, processor 702 may generate executable code or tool calls corresponding to one or more actions in the sequence of actions. In some embodiments, generating executable code or tool calls may include invoking a code-generation engine using the generative large language model to extend low-level capabilities of the robot at runtime.

In step 512, processor 702 may control the one or more robotic manipulators and/or actuators to perform one or more actions of the sequence of actions based on the execution plan.

Referring to FIG. 5B, method embodiment 500B illustrates an example method for creating the execution plan and operating in a closed-loop with iterative refinement and predicate grounding. In some embodiments, method embodiment 500B may be use used to implement one or features of step 508.

In step 514, processor 702 may determine a plurality of plausible actions based at least in part on a current state of the robotic system and the intent and associated context. In some embodiments, determining the plurality of plausible actions may include: determining, based at least in part on a current state of the robot, a first plausible action; determining, based on at least in part on the context of the command, a second plausible action representing a transition from the current state of the robot; and determining a score indicating whether the plurality of plausible actions satisfy a requirement of the natural language command, the plurality of plausible actions having the first plausible action and the second plausible action.

In step 516, processor 702 may generate one or more preconditions for each plausible action of the plurality of plausible actions. In some embodiments, generating the one or more preconditions for each plausible action of the plurality of plausible actions may include: determining a change to the environment; and generating, based at least in part on the change to the environment, the one or more preconditions for each plausible action of the plurality of plausible actions.

In step 518, processor 702 may determine, for each plausible action, whether that plausible action meets or is likely to meet the one or more preconditions associated with that plausible action.

In step 520, processor 702 may self-reflectively evaluate and revise one or more branches of the tree search when a feasibility threshold is not met.

In step 522, processor 702 may determine the sequence of actions comprising a set of the plausible actions that meets or is likely to meet the one or more preconditions.

In some embodiments, creating the execution plan may further include: determining that at least one plausible action is unlikely to meet one or more preconditions associated with the at least one plausible action; providing feedback specifying that the one or more preconditions associated with the at least one plausible action is unlikely to be met; and refining, based at least in part on the feedback, the execution plan by at least one of: generating one or more alternative plausible actions to replace the at least one plausible action; or adjusting one or more future actions to avoid proposing actions whose preconditions are unlikely to be met.

### Example Method of Robotic Task Execution Using Natural Language

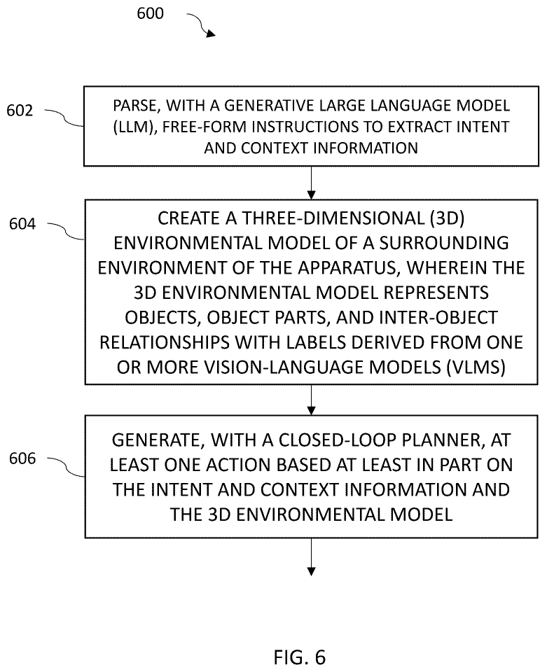

FIG. 6 illustrates an example method embodiment 600 in accordance with the present technology. While FIG. 6 will be discussed in the context of FIG. 1, this is for clarity of explanation purposes only and the method described in FIG. 6 should not be considered limited by the block diagram illustrated in FIG. 1. Method 600 may be performed, for example, by processor 702 of computer device 700 of FIG. 7 described below. While an order of operations is indicated in FIG. 6 for illustrative purposes, the timing and ordering of such operations may vary where appropriate without negating the purpose and advantages of the examples set forth in detail.

In step 602, processor 702 may parse, with a generative large language model (LLM), free-form instructions to extract intent and context information.

In step 604, processor 702 may create a three-dimensional (3D) environmental model of a surrounding environment of the apparatus, wherein the 3D environmental model represents objects, object parts, and inter-object relationships with labels derived from one or more vision-language models (VLMs). In some embodiments, the generative LLM, the one or more VLMs, and the closed-loop planner may be accessed from the at least one memory of the computer of the robot. In some embodiments, the 3D environmental model is stored in the at least one memory of the computer of the robot.

In step 606, processor 702 may generate, with a closed-loop planner, at least one action based at least in part on the intent and context information and the 3D environmental model. In some embodiments, the closed-loop planner may be a Monte Carlo Tree Search. In some embodiments, generating the at least one action may include: generating at least one plausible action based at least in part on the intent and context information and the 3D environmental model; checking one or more preconditions of the at least one plausible action against the 3D environmental model and one or more capabilities of the apparatus; and in response to the one or more preconditions passing the checking, generating the at least one action, wherein the at least one action includes one or more signals that control the apparatus.

In some embodiments, method embodiment 600 may further include at least one of: controlling at least one robotic manipulator to perform the at least one action; or controlling at least one actuator to perform the at least one action.

### Exemplary Computer System

FIG. 7 depicts an example computer apparatus 700 for use with one or more embodiments described herein.

As an example, apparatus 700 may be a computer to implement certain techniques disclosed herein, such as a computing device to implement the process flows of one or more of FIGS. 1, 3, 5, and 6. As an example, the steps in the methods illustrated in one or more of FIGS. 1, 3, 5, and 6 may be performed by one, two, three, four, or more apparatuses 700. As an example, apparatus 700 may be a smartphone or other portable computer device (e.g., a tablet or a laptop), a personal computer, or the like, to perform the steps in the methods described in one or more of FIGS. 1, 3, 5, and 6.

Apparatus 700 may include one or more processors 702, one or more memory 703, one or more input devices 705, and one or more output devices 706. In some embodiments, apparatus 700 may be a computer that includes a web browser or a software application.

Input to apparatus 700 may be provided by one or more input devices 705, provided from one or more input devices in communication with apparatus 700 via link 701 (e.g., a wired link or a wireless link; e.g., with a direct connection or over a network), and/or provided from another computer(s) in communication with apparatus 700 via link 701. Link 701 may provide a network interface to other computing devices via a network, such as the Internet, a local area network (LAN), a wide area network (WAN), a cellular phone network or hot spot, a cable modem, or the like. Link 701 may include, for example, a wired or wireless network adapter and/or a wireless data transceiver for use with a mobile telecommunications network. Input device 705 may include, for example, a keyboard, a touchpad, a keypad, a pointing device, a mouse, a stylus, a touch sensitive panel (e.g., a touch pad or a touch screen), a biometric input device, a mixed-reality headset, an audio input device, a visible light camera, and/or an infrared camera.

Output for apparatus 700 may be provided by one or more output devices 706, provided to one or more output devices in communication with apparatus 700 via link 701, and/or provided from another computer(s) in communication with apparatus 700 via link 701. Output device 706 may include, for example, a display, a mixed-reality headset, one or more individual LEDs, and/or a speaker.

In some embodiments, one or more input devices 705 and one or more output devices 706 may be combined into one or more unitary input/output devices (e.g., a touch screen on a smartphone or tablet PC).

In some embodiments, based on input from one or more input devices 705 or input from outside apparatus 700 via link 701, one or more processors 702 may perform operations as described herein. As an example, user input may be received from one or more input devices 705. As an example, input may be from another computer in communication with apparatus 700 via link 701. As an example, input may be from one or more input devices in communication with apparatus 700 via link 701.

In some embodiments, one or more processors 702 may perform operations as described herein and provide results of the operations as output. As an example, output may be provided to one or more output devices 706. As an example, output may be provided to another computer in communication with apparatus 700 via link 701. As an example, output may be provided to one or more output devices in communication with apparatus 700 via link 701. An output device may include a display or screen to present a graphical user interface (e.g., a web browser and/or a client application) to a user.

Memory 703 may be accessible by one or more processors 702 so that one or more processors 702 may read information from and write information to memory 703. Memory 703 may store instructions that, when executed by one or more processors 702, implement one or more embodiments described herein. Memory 703 may be a non-transitory computer readable medium (or a non-transitory processor readable medium) containing a set of instructions thereon for robotic task completion in response to natural language requests, wherein when executed by a processor (such as one or more processors 702), the instructions cause the processor to perform one or more methods discussed herein, such as, for example, the methods of FIGS. 5A, 5B, and/or 6. As an example, apparatus 700 may be a smartphone, and memory of the smartphone may store an application, or app, to perform embodiments described herein.

Apparatus 700 may include: one or more processors (such as one or more processors 702); and memory (such as memory 703) accessible by the one or more processors, the memory storing instructions that when executed by the one or more processors, cause the apparatus to perform one or more methods described herein. As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term “processor.”

Memory 703 may be a non-transitory processor readable medium containing a set of instructions thereon, wherein when executed by one or more processors (such as one or more processors 702), the instructions cause the one or more processors to perform one or more methods described herein. In some embodiments, memory 703 may be a local storage device. Additionally, or alternatively, memory 703 may synchronize with or access data from a remote storage location, such as a cloud storage device. In some cases, memory 703 may include a database. The term “non-transitory,” as used herein, is a limitation of the medium itself (i.e., tangible, not a signal) as opposed to a limitation on data storage persistency (e.g., RAM vs. ROM).

### Exemplary Embodiments

In one embodiment, a computer-implemented method for a robot to perform robotic planning and execution in an environment may be provided. The robot may comprise a computer having one or more processors and one or more non-transitory computer-readable media storing instructions executable by the one or more processors to perform the method. The robot may further comprise one or more robotic manipulators and/or actuators to interact with the environment and/or to move through the environment. The method may comprise: computing device including at least one processor in communication with a memory device may be provided. The at least one processor may be configured to: receive a natural language command; process the natural language command with a generative large language model to extract an intent and associated context; create a three-dimensional (3D) open-vocabulary semantic scene graph of the environment, the scene graph comprising nodes for objects and object parts annotated with features from a vision-language model and edges representing relationships, and associating the scene graph with the intent and associated context; create, based at least in part on the scene graph, an execution plan comprising a sequence of actions to complete the natural language command, wherein creating the execution plan comprises operating in a closed-loop with iterative refinement and predicate grounding by: determining a plurality of plausible actions based at least in part on a current state of the robot and the intent and associated context, generating one or more preconditions for each plausible action of the plurality of plausible actions, determining, for each plausible action, whether that plausible action meets or is likely to meet the one or more preconditions by validating against the scene graph, self-reflectively evaluating and revising one or more branches of the tree search when a feasibility threshold is not met, determining the sequence of actions comprising a set of the plausible actions that meets or is likely to meet the one or more preconditions associated with a respective plausible action of the set of plausible actions, and generating executable code or tool calls corresponding to one or more actions in the sequence of actions; and control the one or more robotic manipulators and/or actuators to perform one or more actions of the sequence of actions based on the execution plan.

A further enhancement may include wherein generating the one or more preconditions for each plausible action of the plurality of plausible actions comprises: determining a change to the environment and generating, based at least in part on the change to the environment, the one or more preconditions for each plausible action of the plurality of plausible actions.

A further enhancement may include wherein creating the execution plan further comprises: determining that at least one plausible action is unlikely to meet one or more preconditions associated with the at least one plausible action, providing a feedback specifying that the one or more preconditions associated with the at least one plausible action is unlikely to be met, and refining, based at least in part on the feedback, the execution plan by at least one of: generating one or more alternative plausible actions to replace the at least one plausible action or adjusting one or more future actions to avoid proposing actions whose preconditions are unlikely to be met.

A further enhancement may include wherein determining the plurality of plausible actions comprises: determining, based at least in part on a current state of the robot, a first plausible action, determining, based on at least in part on the context of the command, a second plausible action representing a transition from the current state of the robot, and determining a score indicating whether the plurality of plausible actions satisfy a requirement of the natural language command, the plurality of plausible actions having the first plausible action and the second plausible action.

A further enhancement may include providing real-time feedback to a user of the robot regarding at least one of the actions in the sequence of actions of the execution plan.

A further enhancement may include wherein prior to receiving the natural language command, the robot is not trained with the natural language command, not provided with the natural language command, or not programmed with the natural language command as a possible input.

A further enhancement may include wherein the robot creates the execution plan as part of an initial encounter with the environment.

A further enhancement may include wherein the execution plan is not based on a decision tree provided to the robot.

A further enhancement may include wherein the method is performed on board the robot, and no part of the method is performed by one or more processors remote from the robot.

A further enhancement may include wherein generating executable code or tool calls comprises invoking a code-generation engine using the generative large language model to extend low-level capabilities of the robot at runtime.

A further enhancement may include wherein creating the execution plan comprises performing a Monte Carlo Tree Search guided by the generative large language model.

In another embodiment, a robotic system for planning and execution in an environment may be provided. The robotic system may include: one or more robotic manipulators and/or actuators to interact with the environment and/or to move through the environment; one or more processors; and one or more non-transitory computer-readable media coupled to one or more of the processors and comprising instructions. When executed by the one or more processors, the instructions may cause the robotic system to perform a method comprising: receiving a natural language command; processing the natural language command using a generative large language model to extract an intent and associated context; creating a three-dimensional (3D) open-vocabulary semantic scene graph of the environment, the scene graph comprising nodes for objects and object parts annotated with vision-language features and edges for their relationships, and associating the scene graph with the intent and associated context; creating, based at least in part on the scene graph, an execution plan comprising a sequence of actions to complete the natural language command, wherein creating the execution plan comprises operating in a closed-loop with iterative refinement and predicate grounding by: determining a plurality of plausible actions based at least in part on a current state of the robotic system and the intent and associated context; generating one or more preconditions for each plausible action of the plurality of plausible actions; determining, for each plausible action, whether that plausible action meets or is likely to meet the one or more preconditions associated with that plausible action; self-reflectively evaluating and revising one or more branches of the tree search when a feasibility threshold is not met; determining the sequence of actions comprising a set of the plausible actions that meets or is likely to meet the one or more preconditions; and generating executable code or tool calls corresponding to one or more actions in the sequence of actions; and controlling the one or more robotic manipulators and/or actuators to perform one or more actions of the sequence of actions based on the execution plan.

In another embodiment, a computing device including at least one processor in communication with a memory device may be provided. The at least one processor may be configured to: receive a natural language command; process the natural language command with a generative large language model to extract an intent and associated context; create a three-dimensional (3D) open-vocabulary semantic scene graph of the environment, the scene graph comprising nodes for objects and object parts annotated with features from a vision-language model and edges representing relationships, and associating the scene graph with the intent and associated context; create, based at least in part on the scene graph, an execution plan comprising a sequence of actions to complete the natural language command, wherein creating the execution plan comprises operating in a closed-loop with iterative refinement and predicate grounding by: determining a plurality of plausible actions based at least in part on a current state of the robot and the intent and associated context, generating one or more preconditions for each plausible action of the plurality of plausible actions, determining, for each plausible action, whether that plausible action meets or is likely to meet the one or more preconditions by validating against the scene graph, self-reflectively evaluating and revising one or more branches of the tree search when a feasibility threshold is not met, determining the sequence of actions comprising a set of the plausible actions that meets or is likely to meet the one or more preconditions associated with a respective plausible action of the set of plausible actions, and generating executable code or tool calls corresponding to one or more actions in the sequence of actions; and control the one or more robotic manipulators and/or actuators to perform one or more actions of the sequence of actions based on the execution plan.

In another embodiment, a computing device including at least one processor in communication with a memory device may be provided. The at least one processor may be configured to: parse, with a generative large language model (LLM), free-form instructions to extract intent and context information; create a three-dimensional (3D) environmental model of a surrounding environment of the apparatus, wherein the 3D environmental model represents objects, object parts, and inter-object relationships with labels derived from one or more vision-language models (VLMs); and generate, with a closed-loop planner, at least one action based at least in part on the intent and context information and the 3D environmental model.

A further enhancement may include wherein generating the at least one action comprises: generating at least one plausible action based at least in part on the intent and context information and the 3D environmental model; checking one or more preconditions of the at least one plausible action against the 3D environmental model and one or more capabilities of the apparatus; and in response to the one or more preconditions passing the checking, generating the at least one action, wherein the at least one action includes one or more signals that control the apparatus.

A further enhancement may include wherein the at least one processor may be further configured to control at least one robotic manipulator to perform the at least one action or controlling at least one actuator to perform the at least one action.

A further enhancement may include wherein the generative LLM, the one or more VLMs, and the closed-loop planner are accessed from the at least one memory.

A further enhancement may include wherein the 3D environmental model is stored in the at least one memory.

A further enhancement may include wherein the closed-loop planner is a Monte Carlo Tree Search.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A computer-implemented method for a robot to perform robotic planning and execution in an environment, the robot comprising a computer having one or more processors and one or more non-transitory computer-readable media storing instructions executable by the one or more processors to perform the method, the robot further comprising one or more robotic manipulators and/or actuators to interact with the environment and/or to move through the environment, the method comprising:
receiving a natural language command;
processing the natural language command with a generative large language model to extract an intent and associated context;
creating a three-dimensional (3D) open-vocabulary semantic scene graph of the environment, the scene graph comprising nodes for objects and object parts annotated with features from a vision-language model and edges representing relationships, and associating the scene graph with the intent and associated context;
creating, based at least in part on the scene graph, an execution plan comprising a sequence of actions to complete the natural language command, wherein creating the execution plan comprises operating in a closed-loop with iterative refinement and predicate grounding by:
determining a plurality of plausible actions based at least in part on a current state of the robot and the intent and associated context;
generating one or more preconditions for each plausible action of the plurality of plausible actions;
determining, for each plausible action, whether that plausible action meets or is likely to meet the one or more preconditions by validating against the scene graph;
self-reflectively evaluating and revising one or more branches of a tree search when a feasibility threshold is not met;
determining the sequence of actions comprising a set of the plausible actions that meets or is likely to meet the one or more preconditions associated with a respective plausible action of the set of plausible actions; and
generating executable code or tool calls corresponding to one or more actions in the sequence of actions; and
controlling the one or more robotic manipulators and/or actuators to perform one or more actions of the sequence of actions based on the execution plan.

2. The method of claim 1, wherein generating the one or more preconditions for each plausible action of the plurality of plausible actions comprises:
determining a change to the environment; and
generating, based at least in part on the change to the environment, the one or more preconditions for each plausible action of the plurality of plausible actions.

3. The method of claim 1, wherein creating the execution plan further comprises:
determining that at least one plausible action is unlikely to meet one or more preconditions associated with the at least one plausible action;
providing feedback specifying that the one or more preconditions associated with the at least one plausible action is unlikely to be met; and
refining, based at least in part on the feedback, the execution plan by at least one of:
generating one or more alternative plausible actions to replace the at least one plausible action; or
adjusting one or more future actions to avoid proposing actions whose preconditions are unlikely to be met.

4. The method of claim 1, wherein determining the plurality of plausible actions comprises:
determining, based at least in part on a current state of the robot, a first plausible action;
determining, based on at least in part on the context of the command, a second plausible action representing a transition from the current state of the robot; and
determining a score indicating whether the plurality of plausible actions satisfy a requirement of the natural language command, the plurality of plausible actions having the first plausible action and the second plausible action.

5. The method of claim 1, further comprising providing real-time feedback to a user of the robot regarding at least one of the actions in the sequence of actions of the execution plan.

6. The method of claim 1, wherein, prior to receiving the natural language command, the robot is not trained with the natural language command, not provided with the natural language command, or not programmed with the natural language command as a possible input.

7. The method of claim 1, wherein the robot creates the execution plan as part of an initial encounter with the environment.

8. The method of claim 1, wherein the robot is not trained on the environment.

9. The method of claim 1, wherein the execution plan is not based on a decision tree provided to the robot.

10. The method of claim 1, wherein the method is performed on board the robot, and no part of the method is performed by one or more processors remote from the robot.

11. The method of claim 1, wherein generating executable code or tool calls comprises invoking a code-generation engine using the generative large language model to extend low-level capabilities of the robot at runtime.

12. The method of claim 1, wherein creating the execution plan comprises performing a Monte Carlo Tree Search guided by the generative large language model.

13. A robotic system for planning and execution in an environment, the robotic system comprising:
one or more robotic manipulators and/or actuators to interact with the environment and/or to move through the environment;
one or more processors; and
one or more non-transitory computer-readable media coupled to one or more of the processors and comprising instructions that, when executed by the one or more processors, cause the robotic system to perform a method comprising:
receiving a natural language command;
processing the natural language command using a generative large language model to extract an intent and associated context;
creating a three-dimensional (3D) open-vocabulary semantic scene graph of the environment, the scene graph comprising nodes for objects and object parts annotated with vision-language features and edges for their relationships, and associating the scene graph with the intent and associated context;
creating, based at least in part on the scene graph, an execution plan comprising a sequence of actions to complete the natural language command, wherein creating the execution plan comprises operating in a closed-loop with iterative refinement and predicate grounding by:
determining a plurality of plausible actions based at least in part on a current state of the robotic system and the intent and associated context;
generating one or more preconditions for each plausible action of the plurality of plausible actions;
determining, for each plausible action, whether that plausible action meets or is likely to meet the one or more preconditions associated with that plausible action;
self-reflectively evaluating and revising one or more branches of the tree search when a feasibility threshold is not met;
determining the sequence of actions comprising a set of the plausible actions that meets or is likely to meet the one or more preconditions; and
generating executable code or tool calls corresponding to one or more actions in the sequence of actions; and
controlling the one or more robotic manipulators and/or actuators to perform one or more actions of the sequence of actions based on the execution plan.

14. The robotic system of claim 13, wherein creating the execution plan further comprises performing a Monte Carlo Tree Search guided by the generative large language model.

15. An apparatus comprising:
at least one processor; and
at least one memory including computer program code, the at least one memory and the computer program code configured to, with the at least one processor, cause the apparatus at least to perform a method comprising:
parsing, with a generative large language model (LLM), free-form instructions to extract intent and context information;
creating a three-dimensional (3D) environmental model of a surrounding environment of the apparatus, wherein the 3D environmental model represents objects, object parts, and inter-object relationships with labels derived from one or more vision-language models (VLMs); and
generating, with a closed-loop planner, at least one action based at least in part on the intent and context information and the 3D environmental model.

16. The apparatus of claim 15, wherein generating the at least one action comprises:
generating at least one plausible action based at least in part on the intent and context information and the 3D environmental model;
checking one or more preconditions of the at least one plausible action against the 3D environmental model and one or more capabilities of the apparatus; and
in response to the one or more preconditions passing the checking, generating the at least one action, wherein the at least one action includes one or more signals that control the apparatus.

17. The apparatus of claim 16, wherein the method further comprises at least one of:
controlling at least one robotic manipulator to perform the at least one action; or
controlling at least one actuator to perform the at least one action.

18. The apparatus of claim 15, wherein the generative LLM, the one or more VLMs, and the closed-loop planner are accessed from the at least one memory.

19. The apparatus of claim 15, wherein the 3D environmental model is stored in the at least one memory.

20. The apparatus of claim 15, wherein the closed-loop planner is a Monte Carlo Tree Search.
